(19) United States
(12) Patent Application Publication
(10) Pub. No.: US 2026/0285648 A1
(43) Pub. Date: Sep. 24, 2026

(54) Universal Skid Steer and Compact Equipment Motor Puller

(71) Applicant: Norman Otheim, West Fargo, ND (US)

(72) Inventor: Norman Otheim, West Fargo, ND (US)

(21) Appl. No.: 19/083,177

(22) Filed: Mar. 18, 2025

(51) Int. Cl. B66C 1/22

(52) U.S. Cl. CPC B66C 1/22

(57) ABSTRACT

A universal engine lift tool is disclosed for removing and installing engines in skid-steer and compact equipment. The tool includes a hanger, adjustable legs, and cross-members that can be positioned along a Z-axis. Lift arms mounted to the first cross-member attach to engine lift points, while support arms on the second cross-member provide stabilization. The adjustable design allows for proper positioning in the X, Y, and Z axes, making the tool adaptable to various engine configurations.

### CROSS REFERENCE TO RELATED APPLICATION[S]

None

### BACKGROUND

The present disclosure relates to a universal lift tool, specifically designed for lifting engines in skid-steer type vehicles with inline or transverse-mounted engines, while also being versatile for various other lifting applications.

Service of a skid-steer engine often requires removal of the engine. Some skid-steer manufacturers require a yoke structure specific to the engine arrangement to extract or install the engine.

This background section is intended to introduce the reader to various aspects of art that may be related to various aspects of the present disclosure, which are described and/or claimed below. This discussion is believed to assist the reader with background information to facilitate a better understanding of the various aspects of the present disclosure. Accordingly, it should be understood that these statements are to be read in this light, and not as admissions of prior art.

### SUMMARY

A universal engine lift tool according to one disclosed non-limiting embodiment includes a hanger with a first leg attached on one side and a second leg attached on the opposite side. These legs are connected by a first cross-member and a second cross-member, which run parallel to each other. A first lift arm is mounted at one of several possible positions on the first cross-member, extending across it, while a second lift arm is similarly mounted and positioned parallel to the first. Additionally, a first support arm is mounted at one of several possible positions on the second cross-member, extending across it, with a second support arm mounted in the same way and parallel to the first support arm.

A further embodiment of any of the foregoing embodiments includes a first leg and a second leg that are positioned within the same plane.

A further embodiment of any of the foregoing embodiments of the present disclosure wherein each lift arm consists of a first arm section and a second arm section with a slot in between.

A further embodiment of any of the foregoing embodiments of the present disclosure includes a first attachment on the first arm section with multiple apertures and a second attachment on the second arm section, also with multiple apertures, where each aperture on the first section aligns with one on the second section.

A further embodiment of any of the foregoing embodiments of the present disclosure wherein each of the apertures on the second arm section is threaded.

A further embodiment of any of the foregoing embodiments of the present disclosure wherein the first and second lift arms each have a slot that allows them to fit onto the first cross-member.

A further embodiment of any of the foregoing embodiments of the present disclosure wherein the first cross-member is a flat plate that is oriented along the X-axis and Z-axis.

A further embodiment of any of the foregoing embodiments of the present disclosure wherein the second cross-member consists of two flat plates arranged along the X-axis and Y-axis, with each plate containing multiple apertures along its length.

A further embodiment of any of the foregoing embodiments of the present disclosure includes an adapter that can be attached between the two flat plates of the second cross-member at a specific location along the X-axis.

A further embodiment of any of the foregoing embodiments of the present disclosure includes a support arm that can be secured within the adapter at a chosen position along the Y-axis.

A further embodiment of any of the foregoing embodiments of the present disclosure wherein the support arm features a bumper at its far end.

A further embodiment of any of the foregoing embodiments of the present disclosure wherein the lift tool can lift, take out, and put back an object that's underneath something overhead, without having to move or disturb the thing above it.

An engine lift tool includes an arcuate hanger with a first and second leg attached to it. A first cross-member is secured to the legs at a chosen height along the Z-axis, and a second parallel cross-member is also fastened at a selected height along the Z-axis. A first lift arm is attached to the first cross-member at a chosen position along the X-axis. The second cross-member holds a first adapter and a second adapter, both fastened at selected positions along the X-axis. A first support arm is secured to the first adapter at a chosen position along the Y-axis, while a second support arm is secured to the second adapter at a chosen Y-axis position.

A further embodiment of any of the foregoing embodiments of the present disclosure wherein the first and second lift arms each include a slot designed to accommodate the first cross-member.

A further embodiment of any of the foregoing embodiments of the present disclosure wherein both the first and second lift arms also have a slot that allows a lift chain to pass through in the Z-direction.

A further embodiment of any of the foregoing embodiments of the present disclosure wherein the first and second support arms each have a bumper at their far ends.

A method for lifting a skid steer engine using a lift tool involves attaching a hanger between the first and second legs, positioning cross-members along the Z-axis in relation to the engine's center of gravity, and placing the lift arms along the X-axis to align with the engine's lift points. Fasteners are positioned in the lift arms at a desired Y-axis position corresponding to the engine lift points. A lifting device is then attached to the hanger in alignment with the engine's center of gravity, and support arms are extended to the correct Y-axis distance to make contact with the engine.

A further embodiment of any of the foregoing embodiments of the present disclosure wherein the method includes placing an adapter in the second cross-member to accommodate each support arm and adjusting the support arms so they contact the engine below its center of gravity to help counterbalance it.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a perspective view of a universal engine lift tool according to one disclosed non-limiting embodiment.

FIG. 2 is an exploded view of a universal engine lift tool.

FIG. 3 is an expanded exploded view of cross-member brackets of the universal engine lift tool.

FIG. 4 is a top view of a lift arm for the first cross-member of the universal engine lift tool.

FIG. 5 is a side view of a lift arm for the first cross-member of the universal engine lift tool.

FIG. 6 is an expanded exploded view of a support arm and adapter for the second cross-member of the universal engine lift tool.

FIG. 7 is a flow chart of use and assembly of the universal engine lift tool according to one disclosed non-limiting embodiment.

FIG. 8 is a partial side view of the universal engine lift tool in use.

FIG. 9 is a partial rear view of the universal engine lift tool in use.

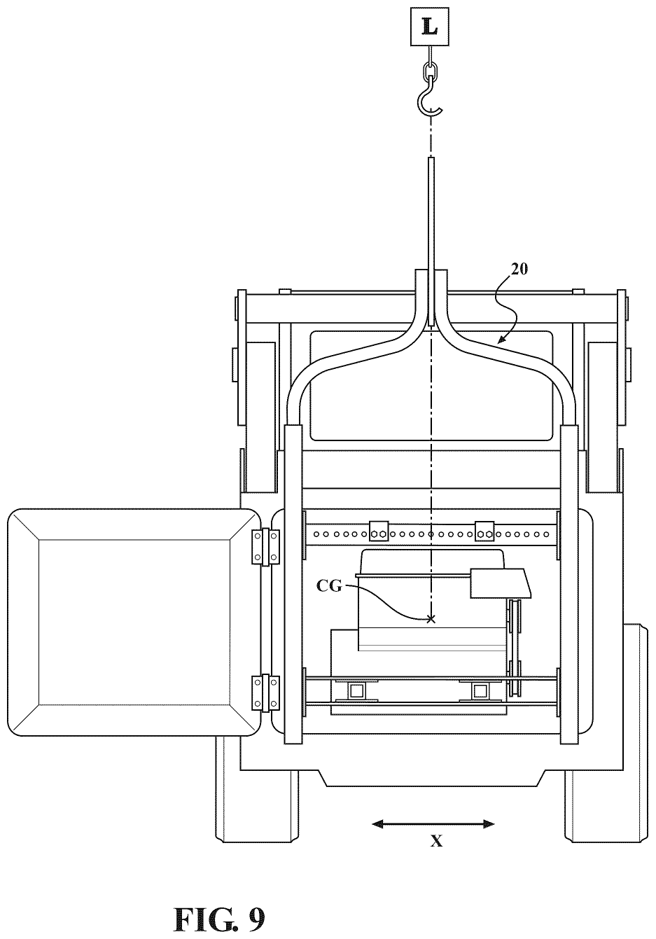

### DETAILED DESCRIPTION

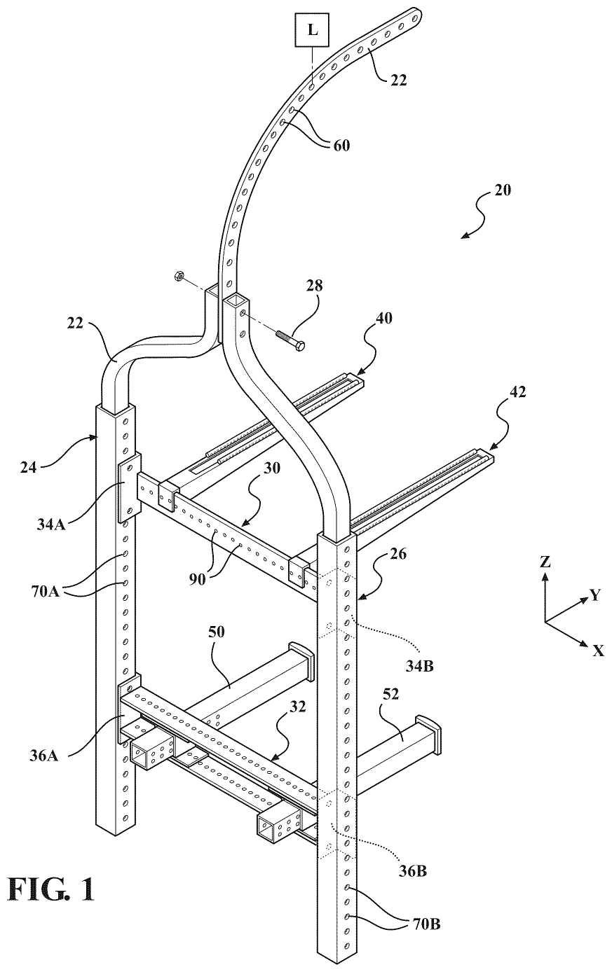

FIG. 1 schematically illustrates a universal engine lift tool 20 primarily utilized to install and remove engines from a skid-steer type vehicle. Skid-steer type vehicles typically have a rear located engine with minimal accessibility.

The universal engine lift tool 20 generally includes a hanger 22, a first leg 24, a second leg 26, a first cross-member 30, a second cross-member 32, a first lift arm 40, a second lift arm 42, a first support arm 50, and a second support arm 52. The hanger 22, the first leg 24, the second leg 26, the first cross-member 30, the second cross-member 32, the first lift arm 40, the second lift arm 42, the first support arm 50, and the second support arm 52 may be manufactured of steel alloys which may be readily assembled and disassembled via fasteners to facilitate universal usage regardless of size, model, manufacturer, or year, as well as storage in a disassembled state.

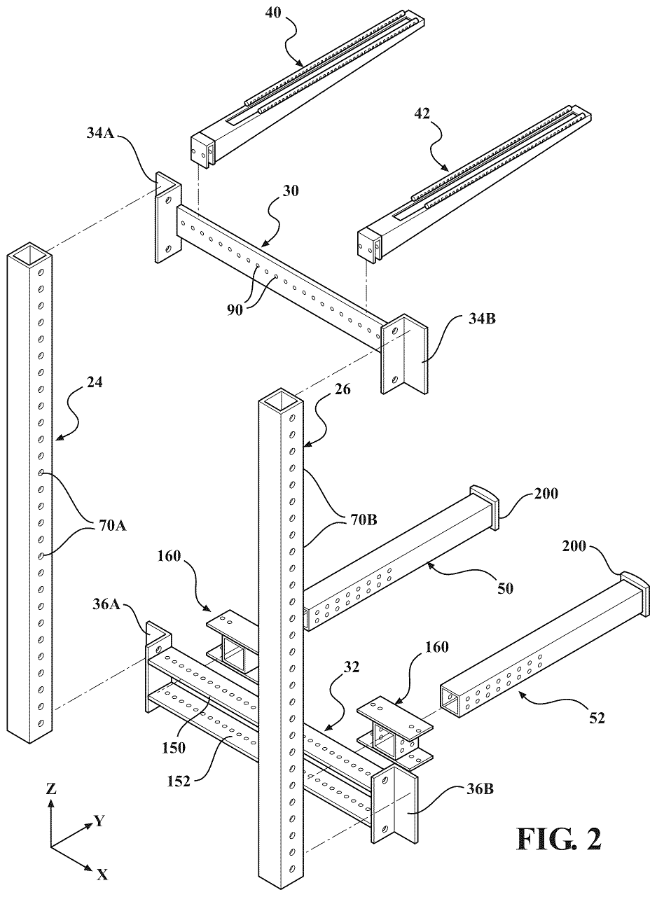

The first leg 24 and the second leg 26 are fastened to the hanger 22 via fasteners 28 such as bolts to form an inverted U-shape, e.g., a “wish-bone” like frame configuration such that the first leg 24 and the second leg 26 are within a common plane (FIG. 2). The common plane herein defines a frame of reference in the X-axis and the Z-axis such that the first lift arm 40, the second lift arm 42, the first support arm 50, and the second support arm 52 extend therefrom in the Y-axis.

The hanger 22 may be arcuate in shape to extend outward of the X-Z plane in the Y-direction from which the first lift arm 40, the second lift arm 42, the first support arm 50, and the second support arm 52 also extend. The hanger 22 includes a multiple of apertures 60 along a length thereof to which a lifting device L such as a hoist, crane, hook, etc., may be attached.

The first leg 24 and the second leg 26 may, for example, be manufactured of a steel alloy that is flat, or as shown in the illustrated embodiment, a tube that is square in cross-section. Although the legs 24, 26, are disclosed in the illustrated embodiment as definite in length, additional steel alloy legs may be connected to the legs 24, 26 to extend length. The first leg 24 and the second leg 26 each include a respective multiple of apertures 70A, 70B along a length thereof. The first cross-member 30 and the second cross-member 32 are mountable between and perpendicular to the first leg 24 and the second leg 26 so as to be arranged within the common X-Z plane.

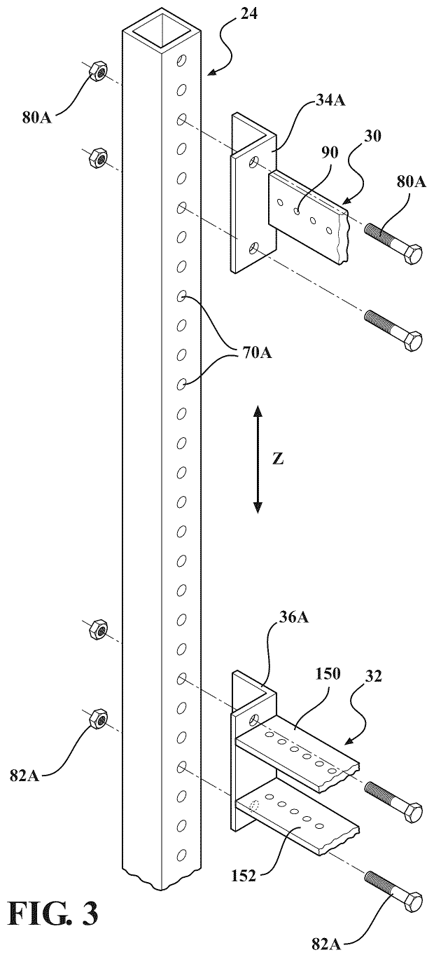

The first cross-member 30 and the second cross-member 32 may each include L-shaped brackets 34A, 34B, 36A, 36B at the distal ends thereof (also shown in FIG. 3). The first cross-member 30 and the second cross-member 32 are respectively assembled to the first leg 24 and the second leg 26 via fasteners 80A, 80B, 82A, 82B, which interface with the brackets 34A, 34B, 36A, 36B and one or more of the multiple of apertures 70A, 70B. Although a particular number of fasteners 80A, 80B, 82A, 82B are disclosed in the illustrated embodiment (e.g., two per bracket), any number may be utilized.

The first cross-member 30 and the second cross-member 32 may be fastened along the respective first leg 24 and the second leg 26 within the common X-Z plane. That is, the first cross-member 30 and the second cross-member 32 are essentially slip fit between then fastened to the respective first leg 24 and the second leg 26 at a desired Z-position.

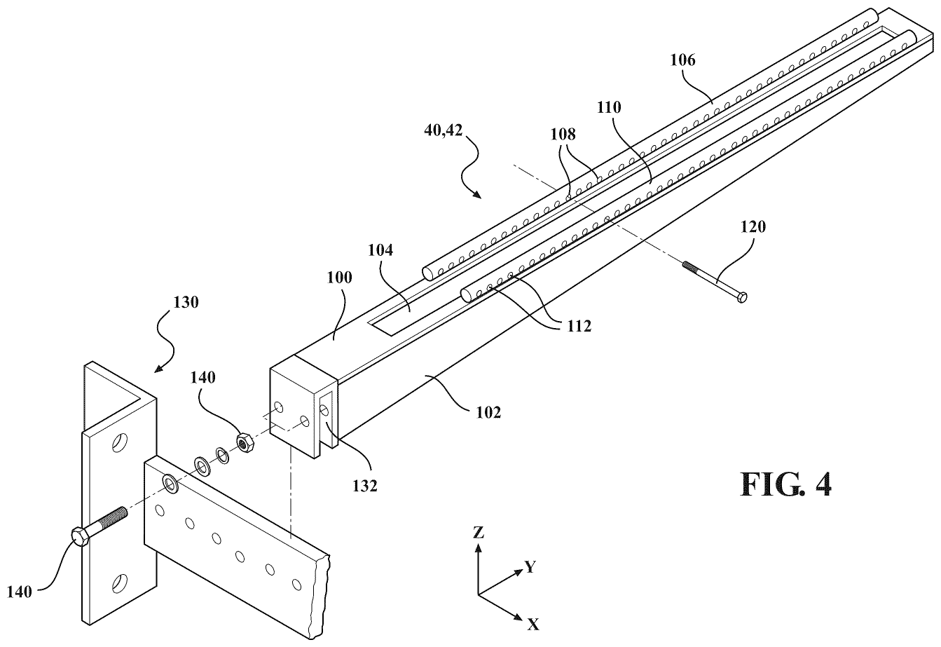

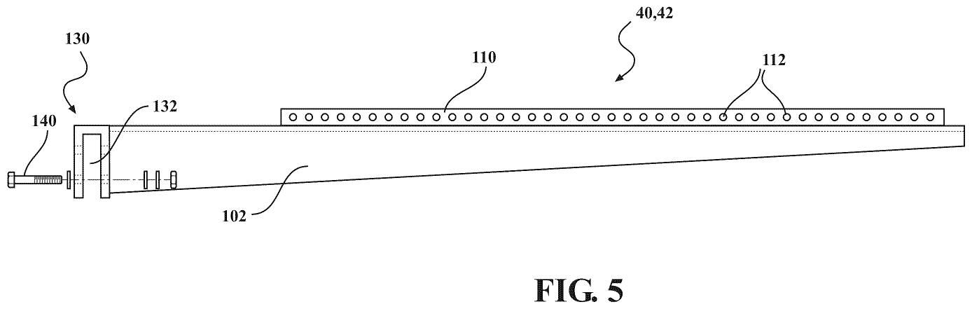

In one embodiment, the first cross-member 30 may include a flat plate arranged in the in the X-axis and the Z-axis such that the L-shaped brackets 34A, 34B, extend in the Y-axis for attachment to the first leg 24 and the second leg 26. A multiple of apertures 90 extend along the length of the first cross-member 30 to which the first and second lift arm 40, 42 (FIGS. 4, 5) are fastened in a desired position along the X-axis. That is, the first cross-member 30 is positioned at a desired Z-position and the first lift arm 40 and the second lift arm 42 are fastened at a desired X-position.

With reference to FIGS. 4 and 5, in one embodiment, the first lift arm 40 and the second lift arm 42 are essentially identical such that only the first lift arm 40 shall be described herein in detail. Although a particular number of lift arms are disclosed in the illustrated embodiment (e.g., two), any number may be utilized.

Each lift arm 40, 42 generally includes a first arm section 100 and a second arm section 102 with a slot 104 therebetween. The first arm section 100 and the second arm section 102 may be triangular in shape to facilitate support from a distal end 130 which attaches to the first cross-member 30. The first arm section 100 and the second arm section 102 may be formed from a flat unitary plate that is formed into the desired cross-sectional shape.

A first attachment 106 along the first arm section 100 includes a first multiple of apertures 108 and a second attachment 110 along the second arm section 102 includes a second multiple of apertures 112. The first attachment 106 and the second attachment 110 may be a drilled rod that is welded to the respective first arm section 100 and the second arm section 102.

The first multiple of apertures 108 are aligned with the second multiple of apertures 112 to receive a fastener 120 such as a bolt which may be threaded into either or both of the first multiple of apertures 108 and/or the second multiple of apertures 112. That is, the first multiple of apertures 108 and/or the second multiple of apertures 112 may be threaded to receive the fastener 120. Alternatively, a fastener with a nut, a pin, or other attachment may be utilized.

The fastener 120 provides an attachment for a lift chain that passes through the slot 104 to attach to the engine. That is, the fastener 120 is positioned through a pair of the multiple of apertures 108, 112 to position the lift chain at a desired Y-position.

The distal end 130 forms a slot 132 in the X-axis transverse to the first arm section 100 and the second arm section 102 which receives the first cross-member 30 (also shown in FIG. 3). That is, the first cross-member 30 is fitted into the slot 132 such that the lift arm 40, 42 hangs thereon. One or more fasteners 140 are arranged through one or more of the multiple of apertures 90 in the first cross-member 30 to fasten the first lift arm 40 to the first cross-member 30 in a cantilevered manner.

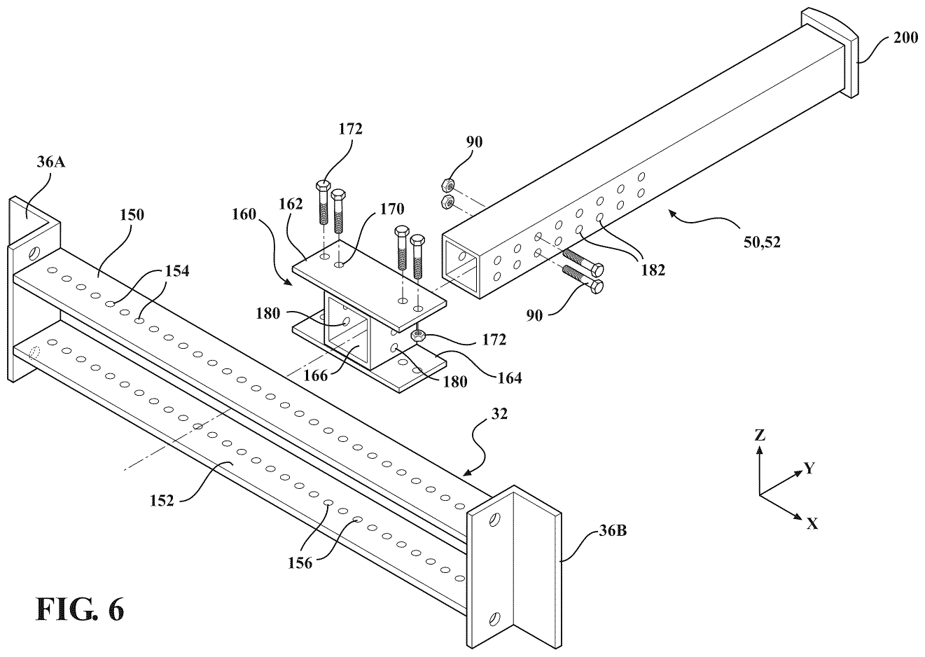

With reference to FIG. 6, in one embodiment, the second cross-member 32 may include a first and second flat plate 150, 152 arranged in the in the X-axis and the Y-axis such that the L-shaped brackets 36A, 36B, extend in the Y-axis for attachment to the first leg 24 and the second leg 26 as with the first cross-member 30 (also shown in FIG. 3). The first and second flat plate 150, 152 include respective apertures 154, 156 which are parallel along respective Z-axes. That is, the second cross-member 32 is an assembly to which one or more adapters 160 may be fastened along the X-axis to position the first support arm 50 and the second support arm 52 in the X-axis.

Each adapter 160 generally includes a first plate 162 and a second plate 164 with a square section 166 therebetween which receives one of the respective support arms 50, 52. The first plate 162 and a second plate 164 each include apertures 170 (two shown on each side of the square section 166) that correspond to the spacing of the respective apertures 154, 156 such that fasteners 172 may be utilized to fasten the adapter 160 between the first and second flat plate 150, 152 at a desired location along the X-axis.

Apertures 180 (two shown in each side), that correspond to the spacing of respective apertures 182 along each of the respective support arms 50, 52, permit receipt of fasteners 190 into selected apertures 182 so as to fasten the respective support arm 50, 52 within the square section 166 at a desired Y-position. That is, the adapter 160 is positioned to define the desired location along the X-axis and the respective support arm 50, 52 is fastened within the square section 166 to define the desired location along the Y-axis.

A distal end of the first support arm 50 and the second support arm 52 may include a bumper 200 at a distal end to abut the engine. The bumper 200 may be manufactured of a non-metallic material such as plastic, rubber, etc.

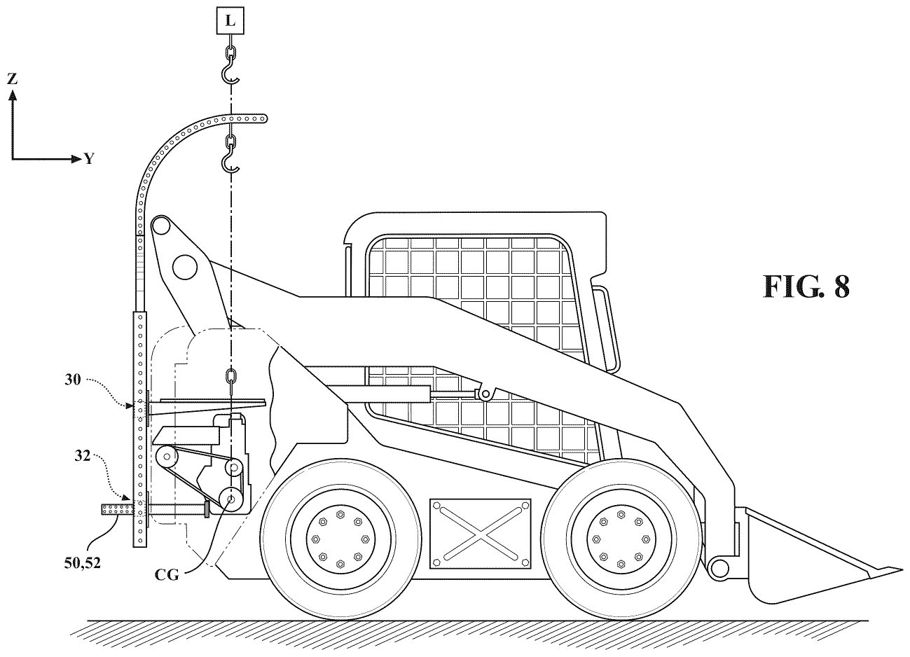

With reference to FIGS. 1 and 8, the hanger 22, first leg 24, second leg 26, first lift arm 40, and second lift arm 42 collectively define a structural gap configured to accommodate an object or component positioned directly over the engine being removed. The gap may be widened or narrowed along the x-axis by moving the first lift arm 40 and second lift arm 42 on the first cross-member 30. The gap may be lengthened or shortened along the z-axis by moving the hanger 22, the first cross member 30, and/or adding extensions pieces to the first leg 24 and second leg 26.

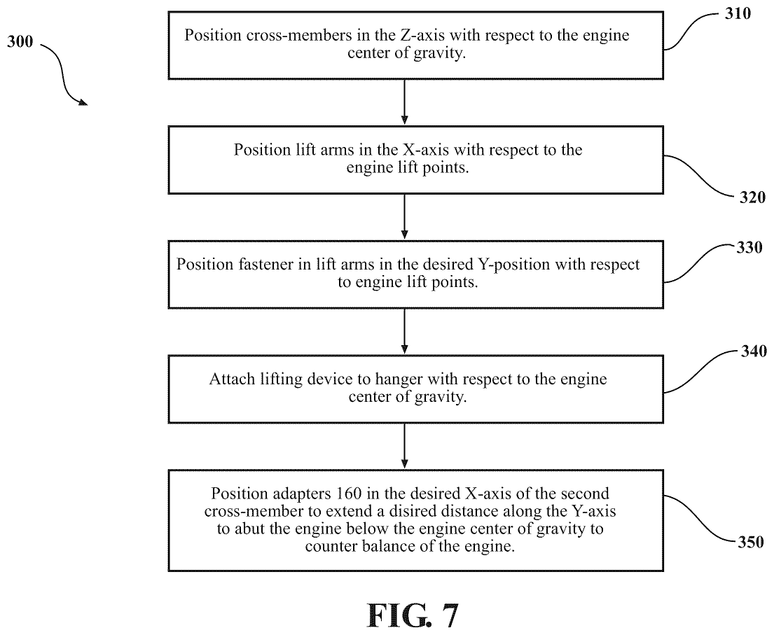

With reference to FIG. 7, in one method 300 of use, the first cross-member 30 and the second cross-member 32 may positioned in the Z-Axis such that the first cross-member 30 is above the engine center of gravity (310; FIG. 8) and the second cross-member 32 is positioned below the center of gravity as most skid steer engines have lift points located with respect to the engine center of gravity such that the engine can be hung on an essentially level plane.

Next, the first lift arm 40 and the second lift arm 42 are fastened to the first cross-member 30 in a position along the X-axis to generally correspond with the position of the engine lift points (320; typically two).

Next, the fastener 120 is positioned through a pair of the multiple of apertures 108, 112 in the first lift arm 40 and the second lift arm 42 to position a lift chain at a desired Y-position (330). Typically, this corresponds with the depth at which the first lift arm 40 and the second lift arm 42 may enter the engine compartment.

Next, the lifting device L is attached to an aperture of the multiple of apertures 60 in the hanger 22 such that a line between the selected aperture in the first lift arm 40 and the second lift arm 42 and the selected aperture in the hanger 60 is generally vertical and thereby passes through the engine center of gravity (340).

Next, one or more adapters 160 (typically two) are positioned at a desired location along the X-axis of the second cross-member 32 and the respective support arm 50, 52 are fastened within the square section 166 to extend a desired along the Y-axis to abut the motor below the engine center of gravity (350).

The engine may then be removed from the engine compartment in a generally level orientation. The adjustable components of the universal engine lift tool 20 in the X, Y, and Z axes facilitate counter balancing of the engine from within the engine compartment. In operation, the forces and stresses required to overcome the weight of the engine are efficiently transferred around the gap throughout the structure of the engine lift tool 20, with particular emphasis on the distributed load among the hanger 22, first leg 24, second leg 26, first lift arm 40, and second lift arm 42.

Although described in a particular sequence of steps, other sequences where other aspects of the engine center of gravity is known, may facilitate selection of apertures, assembly of the universal engine lift tool 20, etc.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed:

1. A lift tool, comprising:
a hanger;
a first leg attachable to the hanger;
a second leg attachable to the hanger opposite the first leg;
a first cross-member attachable to the first leg and the second leg;
a second cross-member attachable to the first leg and the second leg, the second cross-member parallel to the first cross-member;
a first lift arm mountable to one of a multiple of positions on the first cross-member, the first lift arm transvers to the first cross-member;
a second lift arm mountable to one of a multiple of positions on the first cross-member, the second lift arm transvers to the second cross-member and parallel to the first lift arm;
a first support arm mountable to one of the multiple of positions on the second cross-member, the first support arm transvers to the second cross-member; and
a second support arm mountable to one of the multiple of positions on the second cross-member, the second support arm transvers to the second cross-member and parallel to the first support arm.

2. The lift tool as recited in claim 1, wherein the first leg and the second leg are attachable to the hanger to form an inverted U-shape.

3. The lift tool as recited in claim 2, wherein the hanger is arcuate in shape.

4. The lift tool as recited in claim 3, wherein the first leg and the second leg are within a common plane.

5. The lift tool as recited in claim 3, wherein the first lift arm and the second lift arm each comprise a first arm section and a second arm section with a slot there between.

6. The lift tool as recited in claim 5, further comprising a first attachment along the first arm section with a first multiple of apertures and a second attachment along the second arm section with a second multiple of apertures each aperture of the first multiple of apertures aligned with one of the apertures of the second multiple of apertures.

7. The lift tool as recited in claim 5, wherein each of the second multiple of apertures are threaded.

8. The lift tool as recited in claim 7, wherein the first lift arm and the second lift arm each comprise a slot that receives the first cross-member.

9. The lift tool as recited in claim 1, wherein the first cross-member comprises a flat plate arranged in the X-axis and the Z-axis.

10. The lift tool as recited in claim 1, wherein the second cross-member comprises a first and a second flat plate each arranged in the X-axis and the Y-axis, the first and second flat plate each comprising a multiple of apertures along a length thereof.

11. The lift tool as recited in claim 10, further comprising an adapter fastenable between the first and second flat plate at a desired location along the X-axis.

12. The lift tool as recited in claim 11, further comprising a support arm fastenable within the adapter at a desired location along the Y-axis.

13. The lift tool as recited in claim 12, wherein the support arm comprises a bumper at a distal end.

14. The lift tool as recited in claim 1, wherein the lift tool is configured to lift, remove, and reinstall a desired object positioned beneath an overhead obstacle object without requiring removal, disturbance, or interference with the overhead obstacle object.

15. An engine lift tool, comprising:
an arcuate hanger;
a first leg attachable to the hanger;
a second leg attachable to the hanger;
a first cross-member fastenable to the first leg and the second leg at a desired position along a Z axis;
a second cross-member fastenable to the first leg and the second leg at a desired position along the Z axis, the second cross-member parallel to the first cross-member;
a first lift arm fastenable to the first cross-member at desired position along an X-axis;
a first adapter fastenable to the second cross-member at a desired location along the X-axis;
a second adapter fastenable to the second cross-member at a desired location along the X-axis;
a first support arm fastenable to the first adapter at a desired location along the Y-axis; and
a second support arm fastenable to the second adapter at a desired location along the Y-axis.

16. The engine lift tool as recited in claim 15, wherein the first lift arm and the second lift arm each comprise a slot that receives the first cross-member.

17. The engine lift tool as recited in claim 16, wherein the first lift arm and the second lift arm each comprise a slot through which a lift chain extends in a Z-direction.

18. The engine lift tool as recited in claim 15, wherein the first and second support arm each comprises a bumper at a distal end.

19. A method of lifting a skid steer engine with a lift tool, comprising:
fastening a hanger between a first leg and a second leg;
positioning cross-members in a Z-Axis between the first and the second leg with respect to the engine center of gravity;
positioning lift arms in an X-axis with respect to an engine lift point;
positioning fastener in lift arms in a desired Y-position with respect to engine lift points;
attaching a lifting device to the hanger with respect to an engine's center of gravity; and
positioning support arms to extend a desired distance along the Y-axis to abut the engine.

20. The method as recited in claim 19, further comprising positioning an adapter in the second cross-member to receive each support arm.

21. The method as recited in claim 19, further comprising positioning the support arms to abut the engine below the engine center of gravity to counter balance the engine.
